(19) United States
(12) Patent Application Publication
(10) Pub. No.: US 2023/0052657 A1
(43) Pub. Date: Feb. 16, 2023

(54) Peanut Butter Snack Food

(71) Applicant: Kraft Foods Group Brands LLC, Chicago, IL (US)

(72) Inventors: Samuel James McDermott, Chicago, IL (US); Aparna Kothapalli, Hawthorn Woods, IL (US); Connie Wong, Chicago, IL (US)

(21) Appl. No.: 17/785,687

(22) PCT Filed: Dec. 11, 2020
(86) PCT No.: PCT/US2020/064444

§ 371 Date: Jun. 15, 2022

Related U.S. Application Data
(60) Provisional application No. 62/951,702, filed on Dec. 20, 2019.

(51) Int. Cl. A23L 25/10; A23L 7/126; A23L 11/00; A23L 33/185

(52) U.S. Cl. CPC A23L 25/10; A23L 7/126; A23L 11/00; A23L 33/185; A23V 2002/00

(57) ABSTRACT

An example peanut butter snack food includes about 35 wt% to about 45 wt% binder based on a total weight of the peanut butter snack food and about 55 wt% to about 65 wt% particulates based on the total weight of the peanut butter snack food. The binder includes peanut butter and a second binder. The peanut butter is present in an amount within the range of about 10 wt% to about 20 wt% based on the total weight of the peanut butter snack food. The second binder being present in an amount within the range of about 15 wt% to about 30 wt% based on the total weight of the peanut butter snack food.

### FIELD

This application relates generally to peanut butter snack foods.

### BACKGROUND

Peanut butter is an edible paste formed from peanuts that have been roasted or boiled and then crushed, ground, or milled. In addition to the crushed, ground, or milled peanuts, the paste may include ingredients to modify the taste or texture of the peanut butter. Peanut butter can be a source of dietary protein.

Peanut butter is used in snack foods. However, it is difficult to achieve desirable processability, desirable sensory attributes, and desirable protein content in a single peanut butter snack food.

Additionally, when peanut butter is used in combination with other edible binders, protein-protein interaction between the peanut butter and the other edible binder may occur. This protein-protein interaction may reduce the ability of the peanut butter and/or the other edible binder to bind. As such, the protein-protein interaction may prevent the formation of a cohesive product. Instead, the protein-protein interaction may cause the product to crumble and be unable to form a desired shape.

### BRIEF DESCRIPTION OF THE DRAWINGS

FIG. 1 is a black and white reproduction of an originally colored photograph of an example of one form of a peanut butter snack food;

FIG. 2 is a flow diagram illustrating an example of a method of forming a peanut butter snack food;

FIG. 3 is a graph illustrating force (kilograms, Y axis) over time (seconds, X axis) required to move a probe through a comparative example of one form of a peanut butter snack food;

FIG. 4 is a graph illustrating force (kilograms, Y axis) over time (seconds, X axis) required to move a probe through an example of one form of a peanut butter snack food;

FIG. 5 is a graph illustrating force (kilograms, Y axis) over time (seconds, X axis) required to move a probe through another example of a peanut butter snack food;

FIG. 6 is a graph illustrating force (kilograms, Y axis) over time (seconds, X axis) required to move a probe through still another example of a peanut butter snack food; and

FIG. 7 is a graph illustrating force (kilograms, Y axis) over time (seconds, X axis) required to move a probe through another comparative example of a peanut butter snack food.

### DETAILED DESCRIPTION

Described herein is a peanut butter snack food. It has been unexpectedly found that desirable processability, desirable sensory attributes, and desirable protein content can be achieved in the peanut butter snack food by including about 35 wt% to about 45 wt% total binder, about 10 wt% to about 20 wt% peanut butter binder, about 15 wt% to about 30 wt% second binder, and about 55 wt% to about 65 wt% particulates.

It has also been unexpectedly found that protein-protein interaction between the peanut butter binder and the second binder can be reduced by heating and mixing the second binder with the particulates before the heated peanut butter is mixed with the mixture of the second binder and the particulates.

In some examples, the peanut butter snack food disclosed herein includes: about 35 wt% to about 45 wt% binder based on a total weight of the peanut butter snack food, wherein the binder includes peanut butter and a second binder, the peanut butter being present in an amount within the range of about 10 wt% to about 20 wt% based on the total weight of the peanut butter snack food and the second binder being present in an amount within the range of about 15 wt% to about 30 wt% based on the total weight of the peanut butter snack food; and about 55 wt% to about 65 wt% particulates based on the total weight of the peanut butter snack food.

In other examples, the peanut butter snack food disclosed herein includes: about 35 wt% to about 45 wt% binder based on a total weight of the peanut butter snack food, wherein the binder includes peanut butter and a second binder having a dextrose equivalent (DE) value within the range of 40 to 60, the peanut butter being present in an amount within the range of about 10 wt% to about 20 wt% based on the total weight of the peanut butter snack food, the second binder being present in an amount within the range of about 15 wt% to about 30 wt% based on the total weight of the peanut butter snack food; and about 55 wt% to about 65 wt% particulates based on the total weight of the peanut butter snack food.

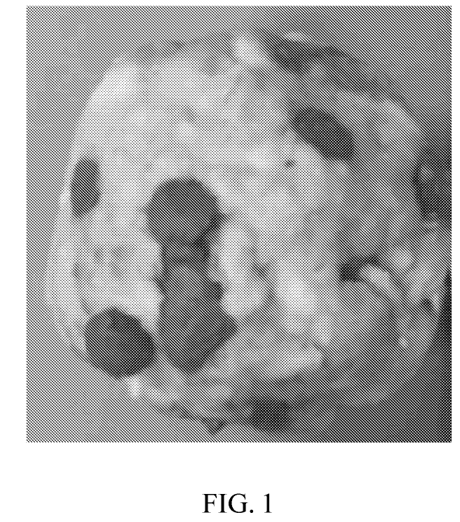

The peanut butter snack food disclosed herein may be in the form of a soft-textured mass or multiple soft-textured masses. As used herein, the term “soft-textured mass” refers to a cohesive composition that can be broken apart in a human mouth. An example of peanut butter snack food disclosed herein is shown in FIG. 1.

While the example peanut butter snack food shown in FIG. 1 is in the shape of a ball, it is to be understood that each soft-textured mass of the peanut butter snack food may be formed into any desirable shape. In some examples, the peanut butter snack food may be in the form of balls, bars, squares, spheres, cylinders, cubes, cuboids, or the like. In other examples, the peanut butter snack food is in the form of balls, bars, spheres, or cuboids.

Each soft-textured mass or shape may have any desirable weight. If the soft-textured mass or shape is too light, it may be more difficult to maintain the cohesive mass or shape desired. In some examples, each soft-textured mass or shape has a weight within the range of about 15 grams to about 40 grams. In other examples, each soft-textured mass or shape has a weight within the range of about 15 grams to about 35 grams, the range of about 15 grams to about 30 grams, the range of about 15 grams to about 25 grams, the range of about 16 grams to about 24 grams, the range of about 15 grams to about 20 grams, the range of about 20 grams to about 25 grams, the range of about 17.25 grams to about 22.75 grams, or the range of about 19.75 grams to about 20.25 grams. In another example, each soft-textured mass or shape has a weight of about 20 grams.

Each soft-textured mass or shape may have any desirable volume. If the soft-textured mass or shape is too small, it may be more difficult to maintain the cohesive mass or shape desired. In some examples, each soft-textured mass or shape has a volume within the range of about 0.525 cubic inches to about 33.5 cubic inches. In other examples, each soft-textured mass or shape has a volume within the range of about 1 cubic inch to about 30 cubic inches, the range of about 2 cubic inches to about 25 cubic inches, the range of about 3 cubic inches to about 20 cubic inches, the range of about 4 cubic inches to about 15 cubic inches, the range of about 5 cubic inches to about 10 cubic inches. In another example, each soft-textured mass or shape has a volume of about 8 cubic inches.

The peanut butter snack food includes binder. As used herein, the term “binder” refers to any food ingredient or combination of food ingredients that acts as a cohering agent. The binder enables the ingredients of the peanut butter snack food to stick together to form the soft-textured mass. In some examples, the binder is a liquid or semisolid at a temperature within the range of about 70° F. to about 105° F. In other examples, the binder is a liquid or semisolid at a temperature within the range of about 85° F. to about 105° F. In examples disclosed herein, the binder includes peanut butter and a second binder.

The binder is present in the peanut butter snack food in an amount within the range of about 35 wt% to about 45 wt% based on the total weight of the peanut butter snack food. In some examples, the binder is present in the peanut butter snack food in an amount within the range of about 35 wt% to about 40 wt% based on the total weight of the peanut butter snack food. In some other examples, the binder is present in the peanut butter snack food in an amount within the range of about 40 wt% to about 45 wt% based on the total weight of the peanut butter snack food. In still some other examples, the binder is present in the peanut butter snack food in an amount of about 40 wt% based on the total weight of the peanut butter snack food.

As mentioned above, the binder includes peanut butter. In some examples, the peanut butter includes from about 70 wt% to about 100 wt% peanuts based on the total weight of the peanut butter. In other examples, the peanut butter includes from about 80 wt% to about 100 wt% peanuts, from about 90 wt% to about 100 wt% peanuts, from about 95 wt% to about 100 wt%, or from about 99 wt% to about 100 wt% peanuts based on the total weight of the peanut butter. In some examples, the peanut butter may include, in addition to the peanuts, another ingredient. Examples of other ingredients that may be included in the peanut butter include sodium chloride salt, a sweetener, an emulsifier, a stabilizer, and combinations thereof. In one example, the peanut butter is a stabilized peanut butter (i.e., the peanut butter includes a stabilizer to prevent oil separation). In another example, the peanut butter is a natural peanut butter (i.e., the peanut butter does not include a stabilizer).

In some examples, the peanut butter is a liquid or semisolid at a temperature within the range of about 95° F. to about 105° F.

The peanut butter is present in an amount within the range of about 10 wt% to about 20 wt% based on the total weight of the peanut butter snack food. In some examples, the peanut butter is present in an amount within the range of about 15 wt% to about 20 wt% based on the total weight of the peanut butter snack food. In some other examples, the peanut butter is present in an amount within the range of about 10 wt% to about 15 wt% based on the total weight of the peanut butter snack food. In still other examples, the peanut butter is present in an amount of about 15 wt% based on the total weight of the peanut butter snack food. In yet other examples, the peanut butter is present in an amount of about 20 wt% based on the total weight of the peanut butter snack food. In still other examples, the peanut butter is present in an amount of about 10 wt% based on the total weight of the peanut butter snack food.

As mentioned above, the binder also includes a second binder. In some examples, the second binder is a single second binder. In other examples, the second binder is a second binder combination.

In some examples, the second binder is a liquid or semisolid at a temperature within the range of about 70° F. to about 105° F. In other examples, the second binder is a liquid or semisolid at a temperature within the range of about 85° F. to about 105° F.

The second binder is present in an amount within the range of about 15 wt% to about 30 wt% based on the total weight of the peanut butter snack food. In some examples, the second binder is present in an amount within the range of about 20 wt% to about 30 wt% based on the total weight of the peanut butter snack food. In some other examples, the second binder is present in an amount within the range of about 15 wt% to about 25 wt%, the range of about 20 wt% to about 25 wt%, or the range of about 25 wt% to about 30 wt%, based on the total weight of the peanut butter snack food. In still other examples, the second binder is present in an amount of about 15 wt%, about 20 wt%, or about 30 wt%, based on the total weight of the peanut butter snack food. In yet other examples, the second binder is present in an amount of about 25 wt% based on the total weight of the peanut butter snack food.

In some examples, the second binder is selected from an oil, honey, a syrup, glycerin, lecithin, sodium chloride salt, and combinations thereof. In other examples, the second binder includes two or more ingredients selected from an oil, honey, a syrup, glycerin, lecithin, sodium chloride salt, and combinations thereof. In still other examples, the second binder may include flavor components in addition to one or more of the above ingredients.

In some examples, oil that may be included in the second binder is a high oleic oil. Examples of the oil that may be included in the second binder include canola oil, peanut oil, olive oil, and combinations thereof. In one example, the second binder includes canola oil.

In some examples, the syrup may be included in the second binder and may be selected to achieve a desired dextrose equivalent (DE) value of the second binder. In some of these examples, the second binder may include a syrup having a DE value within the range of 40 to 60. In others of these examples, the second binder may include a syrup having a DE value within the range of 40 to 45, the range of 40 to 50, the range of 40 to 55, the range of 45 to 50, the range of 45 to 55, the range of 45 to 60, the range of 50 to 55, the range of 50 to 60, or the range of 55 to 60. Examples of the syrup that may be included in the second binder include glucose syrups, sucrose syrups, fructose syrups, brown rice syrup, agave syrup, and combinations thereof. In one example, the second binder includes brown rice syrup.

In some examples of the peanut butter snack food disclosed herein, the second binder has a dextrose equivalent (DE) value within the range of 40 to 60. In other examples, the second binder has a DE value within the range of 40 to 45, the range of 40 to 50, the range of 40 to 55, the range of 45 to 50, the range of 45 to 55, the range of 45 to 60, the range of 50 to 55, the range of 50 to 60, or the range of 55 to 60.

The peanut butter snack food disclosed herein also includes particulates. As used herein, the term “particulates” refers to any dry food ingredient or combination of food ingredients. The particulates are held together by the binder to form the soft-textured mass.

The particulates are present in the peanut butter snack food in an amount within the range of about 55 wt% to about 65 wt% based on the total weight of the peanut butter snack food. In some examples, the particulates are present in the peanut butter snack food in an amount within the range of about 55 wt% to about 60 wt% based on the total weight of the peanut butter snack food. In some other examples, the particulates are present in the peanut butter snack food in an amount within the range of about 60 wt% to about 65 wt% based on the total weight of the peanut butter snack food. In still some other examples, the particulates are present in the peanut butter snack food in an amount of about 60 wt% based on the total weight of the peanut butter snack food.

In some examples, the particulates are selected from isolated soy proteins, soy crisps, rice crisps, wheat crisps, rice puffs, wheat puffs, oats, peanuts, chocolate chips, pea crisps, and combinations thereof. In other examples, the particulates include two or more ingredients selected from isolated soy proteins, soy crisps, rice crisps, wheat crisps, rice puffs, wheat puffs, oats, peanuts, chocolate chips, pea crisps, and combinations thereof. In some of these examples, the particulates include chopped peanuts.

In some examples, the particulates may include a mixture of higher-density ingredients (e.g., oats, peanuts, chocolate chips, etc.) and lower-density ingredients (e.g., soy crisps, rice crisps, wheat crisps, rice puffs, wheat puffs, pea crisps, etc.). In one of these examples, the higher-density ingredients may be present in an amount within the range of about 40 wt% to about 45 wt% or the range of about 41.5 wt% to about 45.5 wt% based on the total weight of the peanut butter snack food. In another of these examples, the higher-density ingredients may be present in an amount of about 43.5 wt% based on the total weight of the peanut butter snack food. In still another of these examples, the lower-density ingredients may be present in an amount within the range of about 10 wt% to about 15 wt% or the range of about 9.75 wt% to about 13.75 wt% based on the total weight of the peanut butter snack food. In yet another of these examples, the lower-density ingredients may be present in an amount of about 11.75 wt% based on the total weight of the peanut butter snack food.

In some examples, the particulates include isolated soy proteins in an amount within the range of about 2 wt% to about 6 wt% based on the total weight of the peanut butter snack food. In other examples, the particulates include soy crisps, rice crisps, wheat crisps, rice puffs, wheat puffs, pea crisps, or a combination thereof in an amount within the range of about 9.75 wt% to about 13.75 wt% based on the total weight of the peanut butter snack food. In still other examples, the particulates include oats in an amount within the range of about 16.25 wt% to about 20.25 wt% based on the total weight of the peanut butter snack food. In yet other examples, the particulates include chocolate chips in an amount within the range of about 11.75 wt% to about 15.75 wt% based on the total weight of the peanut butter snack food. In still other examples, the particulates include peanuts (e.g., chopped peanuts) in an amount within the range of about 5.15 wt% to about 9.15 wt% or the range of about 19 wt% to about 23 wt% based on the total weight of the peanut butter snack food. In yet other examples, the particulates include chocolate chips, peanuts (e.g., chopped peanuts), or a combination thereof in an amount within the range of about 19 wt% to about 23 wt% based on the total weight of the peanut butter snack food.

In some examples, the peanut butter snack food disclosed herein has good or desirable processability. The amount of the binder (i.e., the amount of the peanut butter and the amount of the second binder) and the amount of the particulates contribute to the processability of the peanut butter snack food. The peanut butter snack food may have good or desirable processability if the peanut butter snack food is able to be formed into a desired shape. Being too dry or too sticky may deleteriously affect the processability of the peanut butter snack food.

In some examples, the peanut butter snack food has good or desirable sensory attributes. The amount of the binder (i.e., the amount of the peanut butter and the amount of the second binder) and the amount of the particulates contribute to the sensory attributes of the peanut butter snack food. The peanut butter snack food may have good or desirable sensory attributes if the peanut butter snack food delivers peanut butter taste and/or has good creaminess. Delivering dry mouth feel may deleteriously affect the sensory attributes of the peanut butter snack food.

The peanut butter snack food may have a high protein content. The protein content of the binder (i.e., the protein content of the peanut butter and the protein content of the second binder) and the protein content of the particulates may contribute to the protein content of the peanut butter snack food. In some examples, the peanut butter snack food has a protein content within the range of about 20 wt% to about 30 wt% based on the total weight of the peanut butter snack food. In other examples, the peanut butter snack food has a protein content within the range of about 20 wt% to about 25 wt% or the range of about 25 wt% to about 30 wt%, based on the total weight of the peanut butter snack food.

In some examples, the peanut butter snack food has good or desirable texture. The amount of the binder (i.e., the amount of the peanut butter and the amount of the second binder) and the amount of the particulates contribute to the texture of the peanut butter snack food. The peanut butter snack food may have good or desirable texture if the peanut butter snack food has a chewy texture or a soft texture. In one example, the peanut butter snack food has a chewy texture. In another example, the peanut butter snack food has a soft texture.

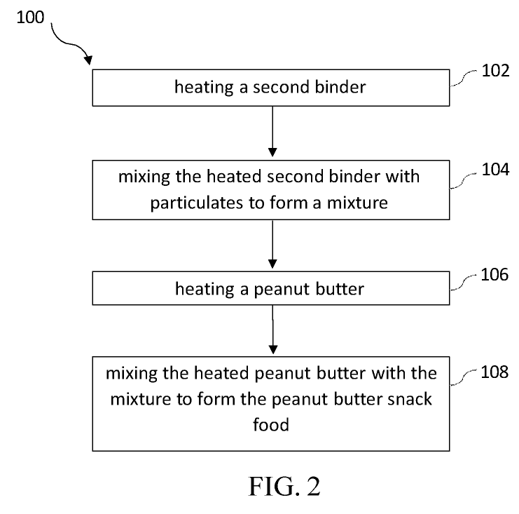

An example of a method 100 of making the peanut butter snack food disclosed herein is shown in FIG. 2. As shown in FIG. 2, the method 100 includes: heating the second binder (as shown at reference numeral 102); mixing the heated second binder with the particulates to form a mixture(as shown at reference numeral 104); heating the peanut butter (as shown at reference numeral 106); and mixing the heated peanut butter with the mixture to form the peanut butter snack food (as shown at reference numeral 108).

In the method 100, it is to be understood that the peanut butter snack food, the peanut butter, the second binder, and the particulates may each be as described above.

As shown at reference numeral 102, the method 100 includes heating the second binder. The second binder may be heated in any suitable manner. In some examples, the second binder may be heated with a heater that provides high shear and uniform heating, such as a jacketed kettle or a jacketed liquifier. In one example, second binder may be heated with a jacketed kettle.

The temperature to which the second binder is heated may depend, in part, on the composition of the second binder used. In some examples, the second binder may be heated to a temperature within the range of about 85° F. to about 105° F. In other examples, the second binder may be heated to a temperature within the range of about 85° F. to about 100° F., the range of about 85° F. to about 95° F., the range of about 85.5° F. to about 94.5° F., the range of about 85° F. to about 90° F., the range of about 90° F. to about 105° F., the range of about 90° F. to about 100° F., or the range of about 90° F. to about 95° F. In still other examples, the second binder may be heated to about 90° F.

As shown at reference numeral 104, the method 100 also includes mixing the heated second binder with the particulates to form a mixture. The heated second binder may be mixed with the particulates in any suitable manner. In some examples, the heated second binder may be mixed with the particulates in a rotary tumbler, a paddle blender, or a single screw mixer. In one example, the heated second binder may be mixed with the particulates in a rotary tumbler.

In some examples, the heated second binder is mixed with the particulates until the mixture is homogenous or substantially homogenous. As used herein, “substantially homogenous” refers to a mixture that includes pieces of some ingredients (such as chocolate chips or peanuts) throughout an otherwise homogenous mixture.

The mixing time of the heated second binder with the particulates may depend, in part, on the batch size (i.e., number of soft-textured masses to be produced), the amount and composition of the second binder used, and/or the amount and composition of the particulates used. In some examples, the heated second binder is mixed with the particulates for about 5 minutes to about 45 minutes. In other examples, the heated second binder is mixed with the particulates for about 5 minutes to about 10 minutes or for about 2 minutes to about 5 minutes. In still other examples, the heated second binder is mixed with the particulates for about 3 minutes.

In some examples, the heated second binder and the particulates are mixed in amounts that result in the peanut butter snack food formed having from about 15 wt% to about 30 wt% second binder and from about 55 wt% to about 65 wt% particulates, based on the total weight of the peanut butter snack food. In other examples, from about 15 wt% to about 30 wt% (based on the total weight of the peanut butter snack food) of the second binder is mixed with about 55 wt% to about 65 wt% (based on the total weight of the peanut butter snack food) of the particulates.

As shown at reference numeral 106, the method 100 further includes heating the peanut butter. The peanut butter may be heated in any suitable manner, such as in any manner of heating described above in reference to the heating of the second binder.

The temperature to which the peanut butter is heated may depend, in part, on the peanut butter used. In some examples, the stabilized peanut butter may be heated to a higher temperature than the temperature to which natural peanut butter is heated. In some examples, the peanut butter may be heated to a temperature within the range of about 85° F. to about 105° F. In other examples, the peanut butter may be heated to a temperature within the range of about 85° F. to about 100° F., the range of about 85° F. to about 95° F., the range of about 85.5° F. to about 94.5° F., the range of about 85° F. to about 90° F., the range of about 90° F. to about 105° F., the range of about 90° F. to about 100° F., or the range of about 90° F. to about 95° F. In still other examples, the peanut butter may be heated to about 90° F.

As shown at reference numeral 108, the method 100 still further includes mixing the heated peanut butter with the mixture to form the peanut butter snack food. The heated peanut butter may be mixed with the mixture in any suitable manner, such as in any manner of mixing described above in reference to the mixing of the heated second binder and the particulates.

In some examples, the heated peanut butter is mixed with the mixture until the peanut butter snack food is homogenous or substantially homogenous. In other examples, the heated peanut butter is mixed with the mixture for about 2 minutes to about 5 minutes. In still other examples, the heated peanut butter is mixed with the mixture for about 3 minutes.

In some examples, the heated peanut butter and the mixture are mixed in amounts that result in the peanut butter snack food formed having from about 10 wt% to about 20 wt% peanut butter, from about 15 wt% to about 30 wt% second binder, and from about 55 wt% to about 65 wt% particulates, based on the total weight of the peanut butter snack food. In other examples, from about 10 wt% to about 20 wt% (based on the total weight of the peanut butter snack food) of the peanut butter is mixed with the mixture. In some of these examples, the mixture includes from about 15 wt% to about 30 wt% (based on the total weight of the peanut butter snack food) of the second binder and about 55 wt% to about 65 wt% (based on the total weight of the peanut butter snack food) of the particulates.

In the method 100, the second binder is heated and mixed with the particulates before the peanut butter is mixed with the mixture of the second binder and the particulates.

It has been unexpectedly found that there is less protein-protein interaction between the second binder and the peanut butter when the second binder and the peanut butter are separately heated and separately mixed with the particulates than when the heated second binder and the heated peanut butter are mixed with the particulates at the same time. As such, it has been unexpectedly found that the separately heating and mixing the second binder and the peanut butter with the particulates affects properties of the peanut butter snack food produced. It is believed that the mixing of one binder component with the particulates before the other binder component is mixed with the mixture reduces the contact between the second binder and the peanut butter, which reduces the protein-protein interaction between the second binder and the peanut butter.

It has also been unexpectedly found that there is less protein-protein interaction between the second binder and the peanut butter when the second binder is heated and mixed with the particulates before the peanut butter is mixed with the mixture of the second binder and the particulates than when the peanut butter is heated and mixed with the particulates before the second binder is mixed with the mixture of the peanut butter and the particulates. As such, it has been unexpectedly found that the mixing order affects properties of the peanut butter snack food produced. It is believed that when the peanut butter is heated and mixed with the particulates before the second binder is mixed with the mixture of the peanut butter and the particulates, the peanut butter coats the particulates and the second binder’s able to bind to the peanut butter is poor.

In any of the examples of the method 100 described above, the second binder and the peanut butter may be separately heated to the same temperature or to substantially the same temperature. As used herein, “substantially the same temperature” refers to temperatures that are within 1° F. of each other. In any of these examples, the second binder and the peanut butter may be separately heated to a temperature within the range of about 85° F. to about 105° F., the range of about 85° F. to about 100° F., the range of about 85° F. to about 95° F., the range of about 85.5° F. to about 94.5° F., the range of about 85° F. to about 90° F., the range of about 90° F. to about 105° F., the range of about 90° F. to about 100° F., or the range of about 90° F. to about 95° F., or a temperature of about 90° F.

In other examples of the method 100, the second binder and the peanut butter may be separately heated to different temperatures. In some of these examples, the second binder is heated to a higher temperature than the temperature to which the peanut butter is heated. In others of these examples, the second binder may be heated to a temperature within the range of about 90° F. to about 105° F. and the peanut butter may be heated to a temperature within the range of about 85° F. to about 95° F.

In any of the examples of the method 100 described above, the method 100 may further include forming the peanut butter snack food into a desirable shape (e.g., a ball, a bar, a square, a sphere, a cylinder, a cube, a cuboid, etc.). In some examples, forming the peanut butter snack food into a desirable shape is accomplished by compaction or compression. The compaction or compression may be accomplished manually or by using manufacturing equipment.

In any of the examples of the method 100 described above, the method 100 may further include packaging the peanut butter snack food.

In any of the examples of the method 100 described above, the peanut butter snack food may quickly cool (e.g., within a one minute) to ambient temperature (e.g. about 70° F.) after being formed into a desirable shape. This may be due, in part, to the peanut butter snack food cooling as the peanut butter is mixed with the mixture of the second binder and the particulates. As such, the peanut butter snack food may be sufficiently cool when the peanut butter snack food is packaged without any additional cooling between forming the peanut butter snack food into a desirable shape and packaging the peanut butter snack food.

To further illustrate the present disclosure, examples are given herein. It is to be understood that these examples are provided for illustrative purposes and are not to be construed as limiting the scope of the present disclosure.

### EXAMPLES

### Example 1

Three examples of the peanut butter snack food disclosed herein were prepared. To prepare the examples, two examples of the second binder disclosed herein were prepared, and two examples of the particulates were prepared.

The general formulations of the example second binders are shown in Table 1, with the wt% of each component that was used (based on the total weight of the second binder).

Table 1

| Ingredient | Example Second Binder 1 (wt%) | Example Second binder 2 (wt%) |
|---|---|---|
| Canola Oil | 9.78 | 9.78 |
| Honey | 8.19 | 8.19 |
| Brown Rice Syrup | 68.49 | 67.98 |
| Glycerin | 8.19 | 8.19 |
| TOPCITHIN® 200 (lecithin) | 3.28 | 3.28 |
| Sodium Chloride Salt | 0.99 | 0.98 |
| Flavor Components | 1.08 | 1.61 |

The general formulations of the example particulates are shown in Table 2, with the wt% of each component that was used (based on the total weight of the particulates).

Table 2

| Ingredient | Example Particulates 1 (wt%) | Example Particulates 2 (wt%) |
|---|---|---|
| Isolated Soy Proteins (87.5 wt% active) | 7.54 | 7.54 |
| Soy Crisps | 21.27 | 21.27 |
| Oats | 33.29 | 33.29 |
| Chocolate Chips | 24.96 | — |
| Chopped Peanuts | 12.94 | 37.9 |

To prepare each of the examples of the peanut butter snack food, one of the example second binders and one of the example particulates were combined with natural peanut butter. The general formulations of the examples of the peanut butter snack food are shown in Table 3, with the wt% of each component that was used (based on the total weight of the peanut butter snack food).

Table 3

| Ingredient | Ex. PB Snack Food 1 (wt%) | Ex. PB Snack Food 2 (wt%) | Ex. PB Snack Food 3 (wt%) |
|---|---|---|---|
| Natural Peanut Butter | 15 | 15 | 15 |
| Example Second Binder 1 | 29.86 | 29.86 | — |
| Example Second Binder 2 | — | — | 29.86 |
| Example Particulates 1 | 55.16 | — | 55.16 |
| Example Particulates 2 | — | 55.16 | — |

To prepare the examples of the peanut butter snack food, all second binder ingredients were combined and heated until the mixture reached 90° F. All particulate ingredients were combined in a rotary tumbler. The natural peanut butter was heated until it reached 90° F. The heated second binder was mixed with the particulates in the rotary tumbler for 3 minutes, after which the mixture appeared to be homogenous. Then, the heated natural peanut butter was added to the mixture, and the combination was mixed in the rotary tumbler for another 3 minutes, after which the mixture appeared to be homogenous. Then, a 20-gram ball was formed from the mixture using manual compression movements.

Each of the examples of the peanut butter snack food had good processability, good sensory attributes, and good protein content. Each of the examples had good ball formation and were not too dry or too sticky. Each of the examples delivered peanut butter taste and had good creaminess. None of the examples delivered dry mouth feel. Each of the examples had a protein content over 20 wt% based on the total weight of the peanut butter snack food.

### Example 2

Additional examples of the peanut butter snack food disclosed herein and comparative examples of the peanut butter snack food were prepared. The additional examples and the comparative examples were prepared with example second binder 1 (from Example 1) and example particulates 2 (from Example 1).

To prepare each of the additional examples and each of the comparative examples, varying amounts of example second binder 1 and example particulates 2 were combined with stabilized peanut butter. The general formulations of the examples and comparative examples of the peanut butter snack food are shown in Table 4, with the wt% of each component that was used (based on the total weight of the peanut butter snack food).

Table 4

| Ingredient | Comparative Ex. PB Snack Food 1 (wt%) | Ex. PB Snack Food 4 (wt%) | Ex. PB Snack Food 5 (wt%) | Ex. PB Snack Food 6 (wt%) | Comparative Ex. PB Snack Food 2 (wt%) |
|---|---|---|---|---|---|
| Stabilized Peanut Butter | 15 | 15 | 15 | 15 | 15 |
| Example Second Binder 1 | 40 | 30 | 25 | 20 | 15 |
| Example Particulates 2 | 45 | 55 | 60 | 65 | 70 |

To prepare the examples and comparative examples of the peanut butter snack food, all of the example second binder 1 ingredients were combined and heated until the mixture reached 90° F. All of the example particulates 2 ingredients were combined in a rotary tumbler. The stabilized peanut butter was heated until it reached 90° F. The heated example second binder 2 ingredients were mixed with the example particulates 2 ingredients in the rotary tumbler for 3 minutes, after which the mixture appeared to be homogenous. Then, the heated stabilized peanut butter was added to the mixture, and the combination was mixed in the rotary tumbler for another 3 minutes, after which the mixture appeared to be homogenous. Then, a 20-gram ball was formed from the mixture using compaction by manufacturing equipment.

The texture of each of examples and comparative examples of the peanut butter snack food was tested by measuring the force required to move a probe through the product.

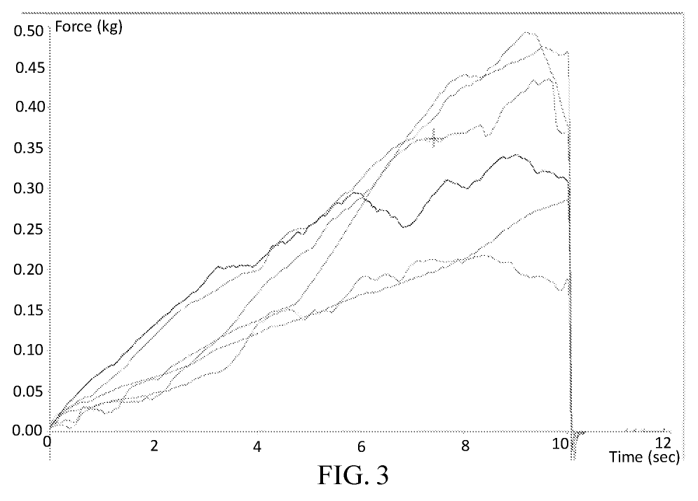

The results of the texture tests are shown in FIG. 3 through FIG. 7. The force values (in kilograms) are shown along the Y axis, and the X axis indicates the amount of time (in seconds) that from the beginning of the test.

FIG. 3 shows the texture results for comparative ex. PB snack food 1. As shown in FIG. 3, comparative ex. PB snack food 1 formed a soft, cohesive, sticky product, which was characterized by a very gradual increase in force as the probe moved through the product and a plateau or small decrease in force as the test was completed. The gradual increase in force was the result of the soft texture. The plateau or small decrease in force was the probe reaching maximum force and retracting from the product. Comparative ex. PB snack food 1 did not break into pieces during the test.

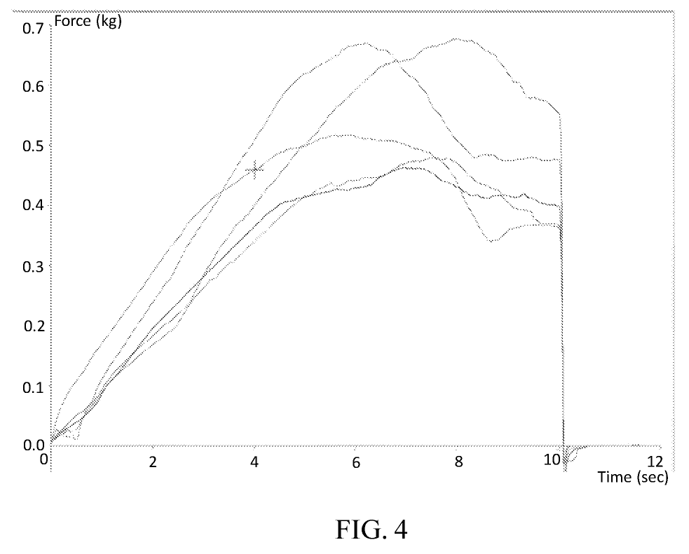

FIG. 4 shows the texture results for ex. PB snack food 4. As shown in FIG. 4, ex. PB snack food 4 formed a soft, cohesive, sticky product, which was characterized by a gradual increase in force as the probe moved through the product and a plateau or small decrease in force as the test was completed. However, the increase in force was less gradual than the increase in force shown in FIG. 3 (for comparative ex. PB snack food 1). The gradual increase in force was the result of the soft texture. The plateau or small decrease in force was the probe reaching maximum force and retracting from the product. Ex. PB snack food 4 did not break into pieces during the test.

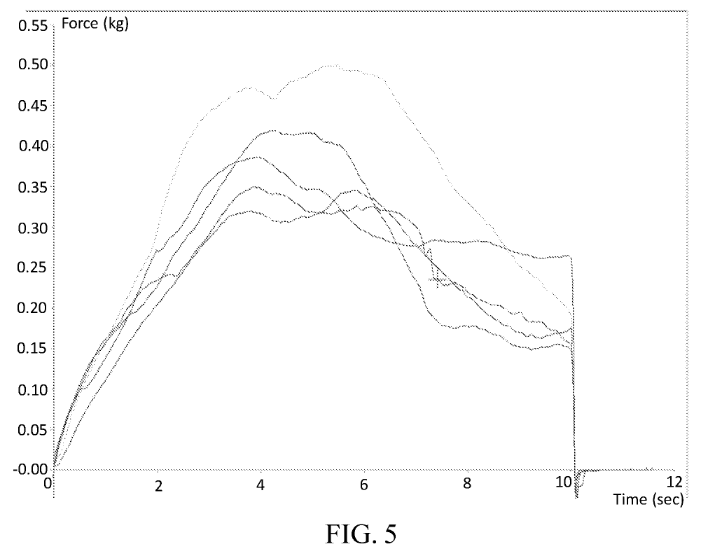

FIG. 5 shows the texture results for ex. PB snack food 5. As shown in FIG. 5, ex. PB snack food 5 formed a chewy product, which was characterized by a sharp increase in force as the probe moved through the product and a plateau or small decrease in force as the test was completed. The sharp increase in force was the result of the chewy texture. The plateau or small decrease in force was the probe reaching maximum force and retracting from the product. Some of the products formed from ex. PB snack food 5 broke into pieces during the test and some did not. Ex. PB snack food 5 broke into 0-2 pieces.

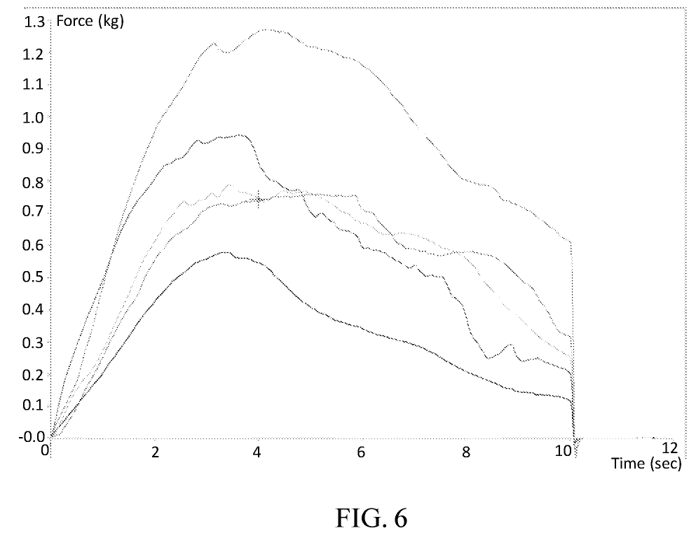

FIG. 6 shows the texture results for ex. PB snack food 6. As shown in FIG. 6, ex. PB snack food 6 formed a chewy product, which was characterized by a sharp increase in force as the probe moved through the product and a plateau or small decrease in force as the test was completed. However, the increase in force was sharper than the increase in force shown in FIG. 5 (for ex. PB snack food 5). The sharp increase in force was the result of the chewy texture. The plateau or small decrease in force was the probe reaching maximum force and retracting from the product. Some of the products formed from ex. PB snack food 6 broke into pieces during the test and some did not. Ex. PB snack food 6 broke into 0-2 pieces.

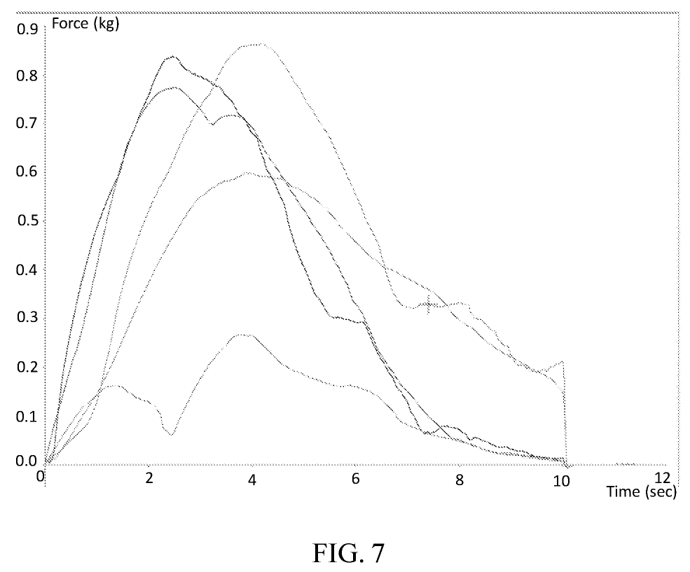

FIG. 7 shows the texture results for comparative ex. PB snack food 2. As shown in FIG. 7, comparative ex. PB snack food 2 formed a brittle product, characterized by a sharp increase in force required to move the probe through the product and a sharp decrease in force as the test was completed. The increase in force was sharper than the increase in force shown in FIG. 6 (for ex. PB snack food 6). The sharp increase in force was the result of the brittle texture, and the sharp decrease was the result of the product crumbling apart when the force was applied to it. Comparative ex. PB snack food crumbled into 3-4 pieces.

Each of the comparative example snack foods had poor processability. Comparative ex. PB snack food 1 was too sticky, and comparative ex. PB snack food 2 was too brittle.

It is to be understood that the ranges provided herein include the stated range and any value or sub-range within the stated range. For example, a range from about 35 wt% to about 45 wt% should be interpreted to include not only the explicitly recited limits of about 35 wt% to about 45 wt%, but also to include individual values, such as 37.35 wt%, 39.5 wt%, 40 wt%, 42.75 wt%, 44 wt%, etc., and sub-ranges, such as from about 36 wt% to about 40.5 wt%, from about 38.5 wt% to about 42.7 wt%, from about 39.75 wt% to about 44 wt%, etc. Furthermore, when “about” is utilized to describe a value, this is meant to encompass minor variations (up to+/- 10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A peanut butter snack food, comprising:
about 35 wt% to about 45 wt% binder based on a total weight of the peanut butter snack food, wherein the binder includes peanut butter and a second binder, the peanut butter being present in an amount within the range of about 10 wt% to about 20 wt% based on the total weight of the peanut butter snack food and the second binder being present in an amount within the range of about 15 wt% to about 30 wt% based on the total weight of the peanut butter snack food; and
about 55 wt% to about 65 wt% particulates based on the total weight of the peanut butter snack food.

2. The peanut butter snack food as defined in claim 1 wherein the second binder is selected from an oil, honey, a syrup, glycerin, lecithin, sodium chloride salt, and combinations thereof.

3. The peanut butter snack food as defined in claim 1 wherein the particulates are selected from isolated soy proteins, soy crisps, rice crisps, wheat crisps, rice puffs, wheat puffs, oats, peanuts, chocolate chips, pea crisps, and combinations thereof.

4. The peanut butter snack food as defined in claim 1 wherein the peanut butter snack food has a protein content within the range of about 20 wt% to about 30 wt% based on the total weight of the peanut butter snack food.

5. A peanut butter snack food, comprising:
about 35 wt% to about 45 wt% binder based on a total weight of the peanut butter snack food, wherein the binder includes peanut butter and a second binder having a dextrose equivalent (DE) value within the range of 40 to 60, the peanut butter being present in an amount within the range of about 10 wt% to about 20 wt% based on the total weight of the peanut butter snack food, the second binder being present in an amount within the range of about 15 wt% to about 30 wt% based on the total weight of the peanut butter snack food; and
about 55 wt% to about 65 wt% particulates based on the total weight of the peanut butter snack food.

6. The peanut butter snack food as defined in claim 5 wherein the second binder includes two or more ingredients selected from an oil, honey, a syrup, glycerin, lecithin, sodium chloride salt, and combinations thereof.

7. The peanut butter snack food as defined in claim 5 wherein the particulates are selected from isolated soy proteins, soy crisps, rice crisps, wheat crisps, rice puffs, wheat puffs, oats, peanuts, chocolate chips, pea crisps, and combinations thereof.

8. The peanut butter snack food as defined in claim 5 wherein the peanut butter snack food has a protein content within the range of about 20 wt% to about 30 wt% based on the total weight of the peanut butter snack food.
